(19) United States
(12) Patent Application Publication
(10) Pub. No.: US 2025/0237278 A1
(43) Pub. Date: Jul. 24, 2025

(54) METHOD FOR THE MANUFACTURE OF BRAKE PADS WITH MODIFIED BACKING PLATE

(71) Applicant: TMD Friction Services GmbH, Leverkusen (DE)

(72) Inventors: Tomasz GRABIEC, Bergisch Gladbach (DE); Christian STOLZ, Leverkusen (DE); Ioannis BUZIDIS, Leverkusen (DE); Achim DOHLE, Leverkusen (DE)

(73) Assignee: TMD Friction Services GmbH, Leverkusen (DE)

(21) Appl. No.: 19/019,690

(22) Filed: Jan. 14, 2025

(30) Foreign Application Priority Data
Jan. 23, 2024 (DE) 102024101835.6

(51) Int. Cl. F16D 65/092; B24C 1/06; F16D 65/00

(52) U.S. Cl. CPC F16D 65/092; B24C 1/06; F16D 65/0006; F16D 2200/003; F16D 2250/0038; F16D 2250/0061; F16D 2250/0069

(57) ABSTRACT

A method for manufacturing a brake pad which has a backing plate and a friction lining, has at least the following steps: (a) preparing a backing plate for attaching a friction lining, with or without an intermediate layer between the backing plate and the friction lining, on the backing plate; (b) roughening at least part of the surface area of the backing plate using a pulsed high-pressure water jet; and (c) attaching the friction lining onto the roughened surface of the backing plate.

### BACKGROUND OF THE INVENTION

The present invention relates to a method of manufacturing brake pads, in particular disc brake pads, which is characterized, inter alia, by pretreating or modifying the brake pad carrier plate (backing plate).

Brake pads for motor vehicles usually consist of a backing plate and a friction lining attached to it. An additional intermediate layer can be fitted between the friction lining and the backing plate, which often acts as a noise-damping layer. In this case, this intermediate layer is attached to the friction lining and the backing plate. The friction lining or the intermediate damping layer is usually attached to the backing plate with an adhesive. If the friction lining consists of sintered materials or contains a sufficient amount of these, it can also be attached to the backing plate through hot pressing instead of adhesive. In addition, the friction lining can also be attached to the surface of the backing plate using fasteners such as bolts, pins and rivets.

To improve the bonding of the friction lining or intermediate layer with the backing plate, the surface of the plate is treated or generally prepared using the latest technology. For this purpose, the backing plate is mechanically treated, for example, to create small roughnesses on the surface of the plate (crimping). If the plates are made of a cast material such as gray cast iron, for example, the retaining elements can be attached directly to the surface of the plate or its edges during casting. Finally, the backing plate can also be treated to adhere better to the friction lining by using laser beams or sandblasting to structure the surface.

DE 197 12 203 A1, for example, demonstrates a method for manufacturing a brake pad. In the event that the backing plate consists of carrier plates made of rolled or unrolled steel, treating the backing plate so that it adheres better to the friction lining, e.g. through a chemical pickling process, sand or water blasting or another surface-removing or deforming process, is described as advantageous. Pickling in a phosphating plant is preferred.

DE 32 32 865 A1 also demonstrates a method for manufacturing a brake pad. A water jet is used to clean an iron pressure plate, creating a surface roughness with an average roughness value (Ra) of 0.8 to 1.3 μm. However, the surface must then be coated to ensure reliable bonding with the friction lining. Dry rough-blasting processes (e.g. sandblasting) achieve surface roughness with an average roughness value (Ra) of 7.7 to 8.7 μm.

U.S. Pat. No. 6,269,669 B1 demonstrates a wet-blasting process with particles for backing plates. According to U.S. Pat. No. 6,269,669 B1, backing plates are conventionally roughened to a surface roughness with an average roughness value (Ra) of between 2 and 7 μm in order to improve bonding with the friction material.

EP 1 178 236 A2 also demonstrates a wet-blasting process with particles for backing plates, wherein a primer is given the preferred surface roughness with an average roughness value (Ra) of 1.5 to 7 μm, to which the friction material is then applied. The preferred roughness depth (Rz) is 10 to 30 μm.

JP 5 328 609 B2 demonstrates a steel ball blasting method for backing plates. The sandblasted backing plates have a surface roughness with a roughness depth (Rz) of between 5 and 15 or 20 μm. After sandblasting, an adhesive for the friction material is applied to the backing plates.

DE 10 2019 213 464 A1 demonstrates a method for manufacturing a friction brake body, wherein the backing plate consists of gray cast iron with embedded graphite. Before applying coating to the friction lining, a water jet is used to reduce or remove the graphite near the surface. Laser cladding is used to apply the coating to the friction lining.

Furthermore, the use of water jet processes for surface treatment is known in the state of the art. The Ecoclean-Group/DE offers processes and equipment for preparing metal surfaces prior to thermal spraying processes to apply hard metals or hard metal alloys.

The measures described above to improve the bonding of the intermediate layer or friction lining to the surface of the backing plate during the manufacture of brake pads are complex, time-consuming and cost-intensive and therefore in need of improvement. They also harbor the risk that additional cleaning steps are required to remove substances added during preparation (e.g. sand particles) or particles produced during processing (e.g. swarf, metal particles).

An objective of the invention is to provide a method for manufacturing brake pads which avoids or minimises as far as possible the disadvantages occurring in the prior art and which simultaneously ensures a firm and durable bond between the friction lining and the backing plate.

Furthermore, the invention aims to determine whether additional advantages, such as increased safety in high-performance applications (e.g. racing), and improved comfort features, such as reduced noise when braking, can be achieved by improving the bond between the friction lining and the backing plate.

### SUMMARY OF THE INVENTION

According to an embodiment of the present invention, when manufacturing a brake pad it is therefore proposed to treat the backing plate by roughening the surface (in whole or in part) to receive the adhesive and the intermediate layer, the adhesive and the friction lining, or preferably the intermediate layer and/or friction lining without the prior application of adhesive. The roughening process herein achieves good adhesion between the backing plate and the friction material or intermediate layer even without the use of adhesive.

The backing plate is prepared by roughening the surface to which the intermediate layer or the friction lining is to be applied. To do this, a layer of adhesive can first be applied to the roughened surface. Preferably, the intermediate layer or the friction lining is hot-pressed directly onto the roughened surface. The parameters used for this, such as pressure and temperature, correspond to the values from the state of the art and are known to specialists in the field of brake manufacture.

A (high-pressure) water jet is used to carry out the roughening process. Appropriate devices for water jet treatments of this type are commercially available and are offered, for example, by the Ecoclean Group/DE.

The preferred designs and parameters for this method according to the invention are explained in more detail below.

So-called pulsating medium-pressure water jet technology, such as that marketed by the company Ecoclean, is the preferred method. The water jet nozzle, preferably in the form of a so-called pulsed water jet nozzle, is operated at a constant working pressure in combination with a so-called ultrasonic transducer. Preferably, the working pressure is up to 850 bar and the pulsation range generated by the ultrasonic transducer is up to approx. 20,000 pulses/s (20 kHz). Preferably, the flow velocity of the water is well above 50 m/s and specifically up to 380 m/s. The water temperature usually corresponds to the pipe temperature (temperature at which the water is made available in the network by the suppliers), or is within the temperature range of the pipe and ambient or room temperature. As a rule, it is not generally necessary to heat the water above room temperature.

It has been shown that the use of pulsed water jets is generally necessary to achieve sufficient roughening of the surface of the backing plate according to the invention. This applies in particular to metal surfaces. The use of pulsed water jets with a water pressure of between 600 and 850 bar is preferable. Preferably, pulsation is between 10 and 25 kHz, even more preferably between 10 and 20 KHz.

Surprisingly, it was found that brake pads with backing plates which have been treated according to the invention cause significantly less noise during braking compared to otherwise identical brake pads with the same backing plates which have not been treated. This is because the backing plates treated according to the invention show an increased damping effect. In the tests carried out so far, damping was increased by between 6.4% and 23% compared to conventional brake pads. This can increase to more than 30% depending on the type of backing plate and friction material. The increased damping effect and consequent significant noise reduction when braking is due to the greatly increased surface roughness that is produced according to the invention, which is far higher than the surface roughnesses conventionally used to date for backing plates.

Thus, the present invention is also a method for reducing noise caused by brake pads during braking while driving, using the brake pads according to the invention for the said purpose and using backing plates according to the invention for the manufacture of brake pads for this purpose.

Surface roughnesses with a roughness depth (Rz) of 50 and up to 500 micrometers are preferred according to the invention; even more preferable are surface roughnesses of 100 to 350 micrometers, specifically 150 to 300 micrometers. The preferable way to measure surface roughness is using a microscope to establish the grinding pattern of the surfaces treated according to the invention. A grinding pattern of this type is shown in FIG. 3.

Various methods for measuring the roughness depth (Rz) are described in the state of the art. In particular, measuring devices from various suppliers that are known to specialists are described (see, for example, the German Wikipedia entry under the keyword “Rauheitsmessung”).

Depending on the type of backing plate and friction material, increased surface roughness with a roughness depth (Rz) of at least 100 μm can result in significantly lower noise levels during braking with brake pads in which the backing plates have been treated according to the invention. Particularly good damping and noise reduction can occur, for example, with a surface roughness with a roughness depth (Rz) of 200 to 300 μm.

General and exemplary information regarding the treatment of metal surfaces and the interaction of process parameters with these materials (using the example of an aluminum alloy A380 and gray cast iron (GCI)) can be found, for example, in the master's thesis by N. O'Neil (“Optimized Surface Roughening by Pulsed Waterjet for Suitable Adhesion Strength of Plasma Transferred Wire Arc Coating”), Carleton University, Ottawa, Ontario, 2020; see pages 49, 53, 63 and 64 (https://repository.library.carleton.ca/downloads/z890rv29c). It also contains information on suitable measuring methods and instruments for various process parameters.

The speed at which the water jet is guided over the surface of the backing plate to be treated is generally between 1 and 10 mm/s, preferably 1 to 4 mm/s and in particular 2 to 3 mm/s. These specifications preferably refer to steel backing plates. Softer materials, such as aluminum or aluminum alloys, can also be roughened at even higher speeds according to the invention.

Preferably, the water jet nozzle is positioned vertically to the surface to be treated. However, treatment can also be carried out at different angles. This is advantageous for treating backing plates that have a partially recessed surface for positioning the friction lining. Treatment at an oblique angle enables even inward-facing edges of the backing plate to be sufficiently roughened. The distance between the surface of the backing plate and the nozzle is preferably in the range of 10 to 70 mm, in particular in the range of 15 to 50 mm.

To ensure that the friction material can penetrate the surface well or is bonded to the surface as firmly as possible, the entire surface of the backing plate is generally treated according to the invention.

According to the invention, it can be advantageous if substances are added to the water used which can prevent corrosion on the surface of the backing plate in the short term. This is preferably triethanolamine in a concentration of less than 3%. One example of a commercial product is Castrol Techniclean HP, which is preferably added to the water in concentrations of 1.5 to 3% by weight.

By producing grinding patterns of the treated surfaces, the penetration of the friction material into the roughened surface can be shown and checked. These images show in good resolution the undercuts and the anchoring of the friction material on the treated surfaces.

Preferred backing plates for the purposes of the present invention are made of steel, preferably mild steel, metal alloys based on Fe and/or Ti, metal alloys with carbon fibers and glass fiber- or carbon fiber-reinforced plastics (GFRP and/or CFRP). Corresponding lightweight backing plates are known in the prior art and are described, for example, in U.S. Pat. No. 2,017,204 920 A1.

According to the invention, the advantages of this method for manufacturing brake pads using backing plates with surfaces roughened through the water jet process are:
The proposed water jet treatment is less time-consuming and cost-intensive than the corresponding methods known in the state of the art for processing the backing plates,
no unwanted residues remain on the surfaces of the backing plates, as is the case with other particle-blasting methods such as sandblasting,
the roughened surface is simultaneously cleaned, eliminating the need for an additional cleaning step,
the water jet treatment does not require the use of additional substances, such as surface-active substances or cleaning agents, which would increase the process costs, and
the method according to the invention is also particularly suitable for low-cost backing plates made of cast materials, such as gray cast iron.

Further objectives, advantages, features, and applications of the present invention are derived from the subsequent description of an exemplary embodiment by way of the drawings. All described and/or depicted features, per se or in any combination, constitute the subject-matter of the present invention, regardless of their summary in the patent claims or their back-reference.

### DESCRIPTION OF THE DRAWINGS

FIG. 1 shows a steel backing plate after delivery in untreated condition (a) and the surface of the same backing plate after water jet treatment according to the invention (b). The water jet has created a clean backing plate surface with undercuts.

FIG. 2 shows the structure of a preferred pulsed water jet nozzle according to the invention.

FIG. 3 shows a schematic representation based on a microscope image of a cross-section or grinding pattern of a backing plate surface treated according to the invention.

FIG. 4 shows a schematic representation based on an SEM (scanning electron microscope) image of a cross-section of a brake pad manufactured according to the invention.

FIG. 5 shows the shape of the waterjet 4 exiting the pulsed water jet nozzle 1 seen in FIG. 2. The waterjet has bubbles, which correspond to the pulsation of the ultrasonic transducer 2 of the pulsed water jet nozzle 1. The pulsed waterjet 4 can generate a cavitation effect on metal surfaces. Examples of this effect are shown in FIG. 6 a, b and c.

FIG. 6 a, b and c show section cuts of an aluminum sample roughened with a pulsed waterjet at different water pressure levels. The water pressure of the water jet is 20 MPa in FIG. 6a, 30 MPa in FIG. 6b, and 40 MPa in FIG. 6c.

FIG. 7 shows damping factor measurements of pad roughened according to the invention and a regular series pad. An all naturel modes (eigenmodes), the roughened pad has a higher damping factor than the series pad. The series pad features brass pins as a friction material retention feature and two chamfers, a top chamfer and a radial chamfer. The roughened pad has the same backplate as the series pad, but omits the brass pins. The roughened pad has the same friction material without chamfers.

### DETAILED DESCRIPTION

With the exception of the roughening of backing plate surfaces according to the invention, the brake pads are manufactured according to methods known in the prior art for applying friction material or a friction lining to a backing plate for the various brake pads (with and also without an intermediate layer between the friction lining and the backing plate). This is usually done by pressing the friction material/friction lining with the backing plate at increased pressure and temperature.

To further increase the stability of the brake pad according to the invention, an adhesive can be applied to the surface of the backing plate before the friction lining is attached.

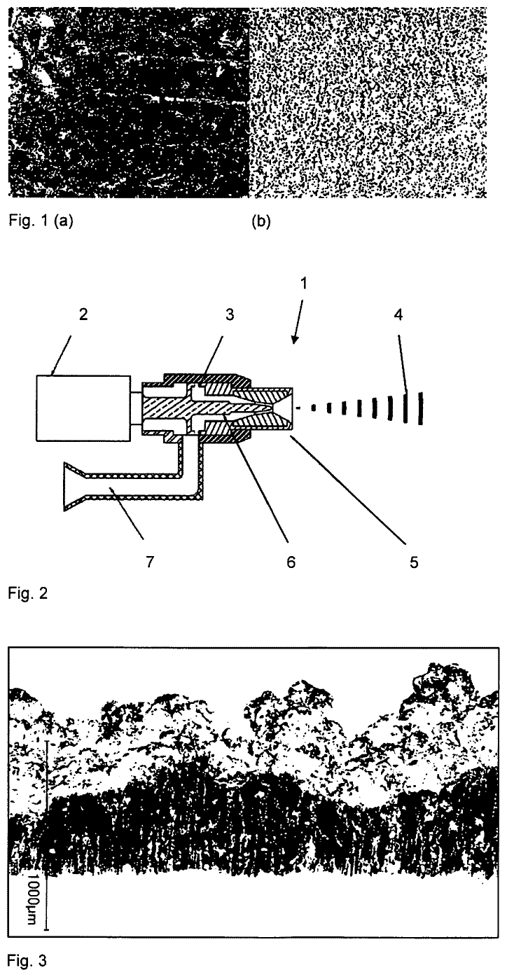

The surface of the backing plate shown in FIG. 1b was treated with a water jet at a speed of 3 mm/s. Treatment was carried out at room temperature. The water jet had a pressure of approx. 760 bar.

The surface of the backing plate shown in FIG. 3 has roughness depths of up to approx. 500 μm. The surface was treated with a water jet at a speed of 1 mm/s. The water jet had a pressure of approx. 760 bar. The surface of the backing plate shown is made of steel.

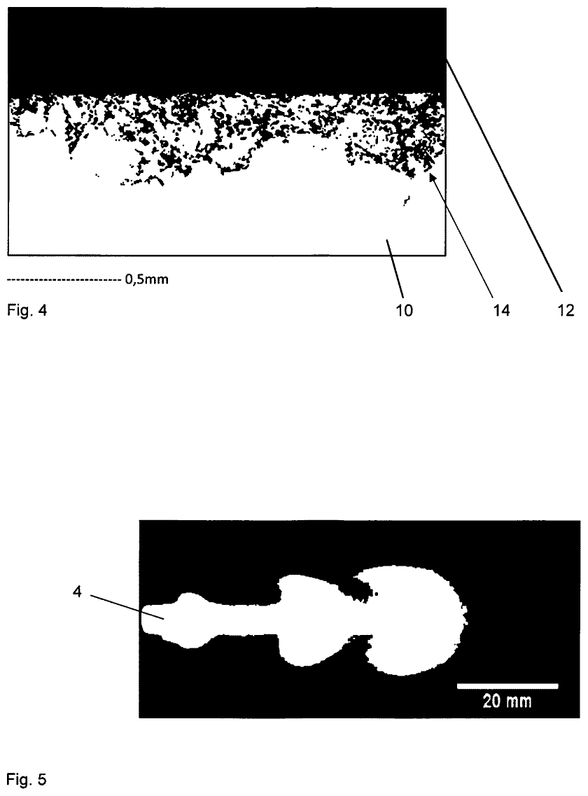

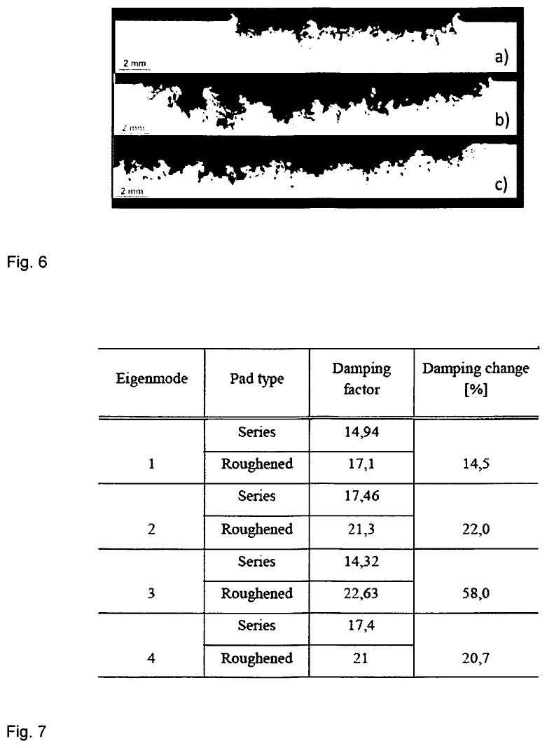

The area to be roughened on the backing plate 10 of the brake pad shown in FIG. 4 was treated with a water jet in accordance with the parameters mentioned in FIG. 1. The backing plate 10 is made of steel. The roughened surface of the backing plate 10 has roughness depths predominantly between 150 and 300 μm. The friction material 12 is pressed directly onto the roughened surface of the backing plate 10. The roughened surface of the backing plate 10 results in interlocking 14 with the friction material 12 and improved bonding, as well as significant noise reduction.

### REFERENCE NUMBERS

1: Pulsed water jet nozzle
2: Ultrasonic transducer
3: High-pressure chamber
4: Pulsed high-pressure water jet
5: Nozzle chamber
6: Oscillating core
7: High-pressure water inlet
10: Backing plate
12: Friction lining
14: Interlocking of the friction lining with the backing plate

1. A method of manufacturing a brake pad having a backing plate and a friction lining, comprising:
a) roughening at least part of the surface area of the backing plate with water emitted from a pulsed high-pressure water jet; and
b) attaching the friction lining, with or without an intermediate layer between the backing plate and the friction lining, onto the roughened surface of the backing plate.

2. The method according to claim 1, wherein the part of the surface area that is roughened is roughened to a surface roughness with a roughness depth of 50 to 500 micrometers.

3. The method according to claim 1, wherein the part of the surface area that is roughened is roughened to a surface roughness with a roughness depth of 100 to 350 micrometers.

4. The method according to claim 1, wherein the surface of the backing plate is not treated with any adhesive after roughening and before applying the friction lining or the intermediate layer.

5. The method according to claim 1, wherein the water jet has a water pressure of 600 to 850 bar.

6. The method according to claim 1, wherein the backing plate comprises aluminum or a metal alloy based on aluminum, and wherein the water jet has a water pressure of 200 to 400 bar.

7. The method according to claim 1, wherein the water jet has a pulsation range of 10,000 to 20,000 pulses/second.

8. The method according to claim 1, wherein the water jet has a velocity of 150 to 380 m/s.

9. The method according to claim 1, wherein the water jet travels over the surface of the backing plate to be roughened at a speed of 1 to 10 mm/s.

10. The method according to claim 1, wherein the water jet travels over the surface of the backing plate to be roughened at a speed of 1 to 4 mm/s.

11. The method according to claim 1, wherein the water jet has an outlet nozzle and the outlet nozzle is moved at a distance of 15 mm to 50 mm from the surface of the backing plate to be roughened.

12. The method according to claim 1, wherein the water jet strikes the surface of the backing plate to be roughened at a vertical angle.

13. The method according to claim 1, wherein the water jet strikes the surface of the backing plate to be roughened at an oblique angle.

14. The method according to claim 1, wherein corrosion-inhibiting substances are added into the water of the water jet.

15. The method according to claim 1, wherein the backing plate comprises a material selected from the group consisting of: metal alloys based on Fe, Ti or aluminum, metal alloys with carbon fibers, glass fiber-reinforced plastics, and carbon fiber-reinforced plastics.

16. A method of reducing braking noise caused by brake pads, comprising: installing in a vehicle a brake pad produced by the method according to claim 1.

17. A method of reducing braking noise caused by brake pads, comprising: installing in a vehicle a brake pad produced by the method according to claim 4.

18. A brake pad manufactured by the method according to claim 1.

19. A brake pad manufactured by the method of claim 4.

20. A motor vehicle, comprising: a brake pad manufactured by the method according to claim 1.
